(19) United States
(12) Patent Application Publication
(10) Pub. No.: US 2005/0166721 A1
(43) Pub. Date: Aug. 4, 2005

(54) Open-ended slot wrench

(76) Inventor: Robert Arthur Bollinger, Lumberton, NC (US)

Correspondence Address: COATS & BENNETT, PLLC, P O BOX 5, RALEIGH, NC, 27602, US

(21) Appl. No.: 10/771,715

(22) Filed: Feb. 4, 2004

(51) Int. Cl. B25B 13/58

(52) U.S. Cl. 81/185.1

(57) ABSTRACT

An adjustable open-ended wrench having a first section and a second section that are spaced apart a distance and forming an opening therebetween. Receivers are located on one or both of the sections. One or more mounts are sized to fit onto the sections and mate with the receivers. The mounts include a reducer section that is positioned within the opening to adjust a width of the opening. This adjustment allows for the wrench to be used on a plurality of work pieces of different sizes. Methods of using the wrench are also disclosed which include connecting one or more mounts to the wrench to adjust the width of the opening so it can be used on a work pieces of different sizes.

### BACKGROUND

An open-ended slot wrench, includes two opposing members that form an opening therebetween. The opposing members are immovable and therefore the opening is sized to fit a single-sized work piece. These wrenches have limited utility as they are not adjustable, and multiple wrenches of different sizes are required if a user is to work on multiple work pieces of different sizes.

A user often becomes frustrated when using these wrenches because of the lack of adjustment. If a user is to look at a work piece and estimate the size incorrectly, the user is forced to get the proper-sized wrench. This is especially frustrating if the user only has a single wrench, or their toolbox containing the other wrenches is located a distance away.

These wrenches are useful because their shape and dimensions allows a user to access work pieces in a variety of different positions. If a work piece is situated in a position having limited access, an open-ended wrench is often the only applicable tool. Other tools, such as socket wrenches, may either have a shape that prevents contact with the work piece, or prevents the user from getting both the tool and their hands and arms in a position to reach the work piece.

Therefore, it is advantageous to have an open-ended wrench that can be adjusted to different sizes such that a user can use an open-end wrench to work on work pieces of various sizes.

### SUMMARY

The present invention is directed to an adjustable open-ended wrench. The slot wrench has a standard configuration having an opening defined by a first member and a second member. The opening is sized to connect to a work piece of a single size. Mounts are removably connectable to one or both of the members to adjust the size of the opening. The mounts include a first section that is positioned within the opening and having a width that adjusts the size of the opening. A second section is positioned within a receiver within the member.

In one embodiment, the wrench includes a receiver and corresponding mount for one receiver. The wrench may be adjusted between a first sized opening when the mount is not connected, and a second size when the mount is attached. In another embodiment, the wrench includes mounts for each of the two members. Each of the two mounts may have the same or a different width. In the two-mount embodiment, a first orientation includes no mounts attached, a second orientation includes a first mount attached, a third orientation includes a second mount attached, and a fourth orientation features attachment of both the first and second mounts.

### BRIEF DESCRIPTION OF THE DRAWINGS

FIG. 1 is an exploded partial perspective view of one embodiment of the present invention with two mounts removed from the wrench members;

FIG. 2 is a side view illustrating a first mount connected to the first member according to one embodiment of the present invention;

FIG. 3 is a cross-sectional view cut along line 3-3 of FIG. 2 illustrating the first mount connected to the first member according to one embodiment of the present invention;

FIG. 4 is an exploded partial perspective view of one embodiment of the mount and corresponding receiver according to the present invention;

FIG. 5 is a cross-sectional view of one embodiment of the present invention with magnets mounted within the first and second members;

FIG. 6 is an exploded partial perspective view of one embodiment of the mount and corresponding receiver according to the present invention;

FIGS. 7A, 7B, 7C, and 7D are side views illustrating different orientations of the wrench according to one embodiment of the present invention;

FIG. 8 is a side view illustrating another embodiment of the present invention having first and second ends; and

FIG. 9 is an exploded partial perspective view of one embodiment of the mount and corresponding receiver according to the present invention.

### DETAILED DESCRIPTION

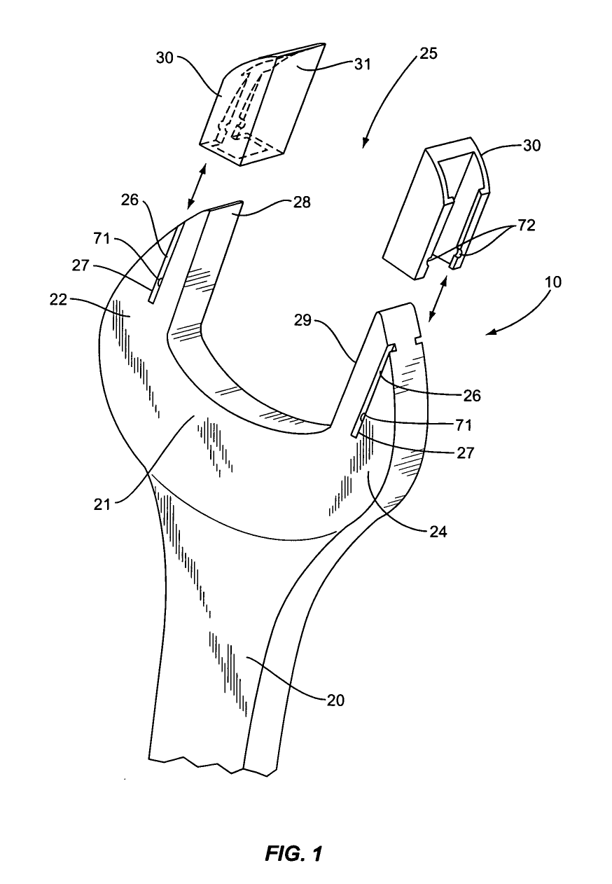

The present invention is directed to an adjustable open-ended wrench 10, as generally illustrated in FIG. 1. The open-ended wrench 20 (hereinafter referred to as wrench 20) includes a first member 22 and a second member 24 being spaced apart a distance and forming an opening 25 therebetween. Receivers 26 are mounted on one or both of the members 22, 24. One or more mounts 30 are sized to fit onto the sections and mate with the receivers 26. The mounts 30 include a reducer section that is positioned within the opening 25 to adjust a width of the opening. This adjustment allows for the wrench 20 to be used on a plurality of work pieces of different sizes.

The term “work piece” is used throughout to generally refer to a member that is to be contacted and rotated by the wrench 20. Examples of work pieces include but are not limited to bolt heads, nuts, fittings, etc.

Wrench 20 is well-known in the art and commonly referred to as an open-ended wrench. Wrench 20 includes a first member 22 and a second member 24 extending outward from the wrench body 21 and forming an opening 25. The body 21 and members 22 may extend a substantial distance around the opening 25. In the example of FIG. 1, the members 22 and body 21 extend around three sides (i.e., bottom, left, and right). A first edge 28 and a second edge 29 contact the work piece when the wrench 20 is engaged. Additionally, an edge of the body 21 may also contact the work piece.

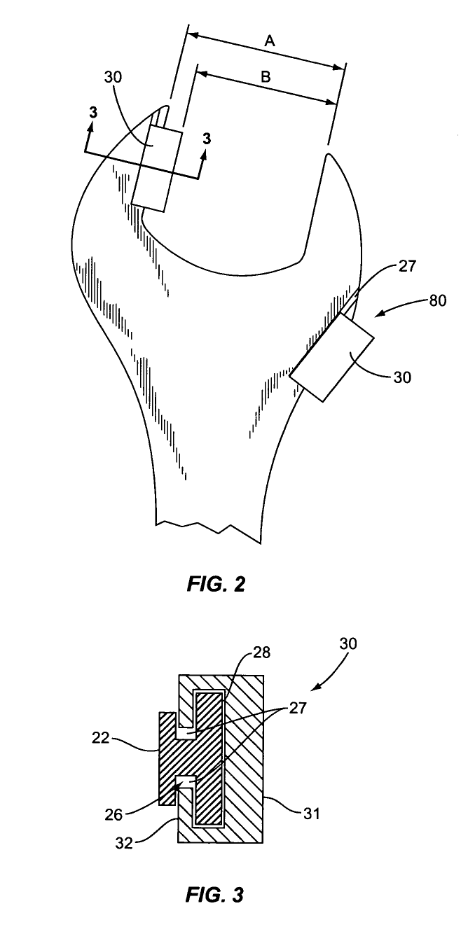

Receivers 26 are mounted on one or both of the first and second members 22, 24. For ease of explanation, only the receiver 26 on the first member 22 will be explained. Receivers 26 may be placed on only one member as illustrated in FIG. 2, or may be placed on both members as illustrated in FIG. 1. In embodiments with receivers 26 on both members 22, 24, the configurations may be the same on each member, or may be different depending upon the application.

Receivers 26 may have a variety of shapes and sizes to conform with the mounts 30. Receivers 26 are positioned to place the mounts within the opening 25. FIG. 1 illustrates one embodiment of the receiver 26 that extends along the first edge 28. FIG. 3 illustrates a cross-sectional view of the receiver 26 that includes a slot 27 formed by a first indent on a first side of the wrench 20, and a second indent on a second side of the wrench 20. In this embodiment, slot 27 is substantially parallel with the edge of the opening 25 (i.e., slot 27 on the first member 22 is substantially parallel with first edge 28).

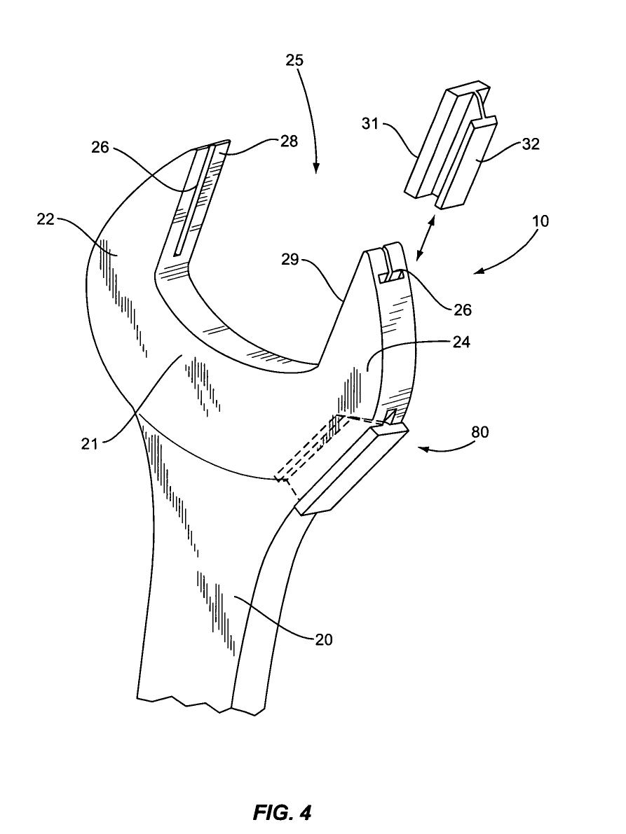

FIG. 4 illustrates another embodiment of the receiver 26. Receiver 26 includes a substantially T-shaped void extending inward from the first edge 28, and a second section having an axis substantially parallel with the first edge 28. In another embodiment (not illustrated), receiver 26 includes only the first section that extends inward from the first edge 28.

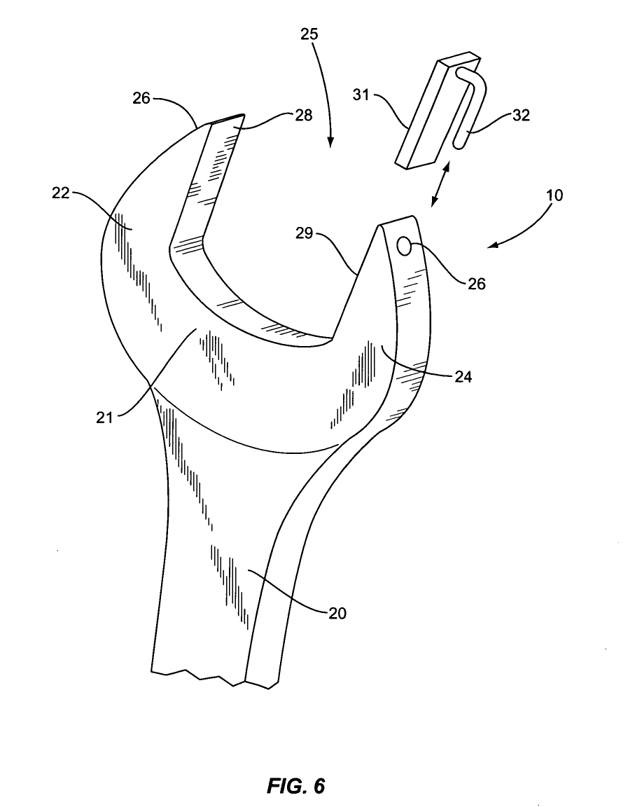

FIG. 6 illustrates yet another embodiment of a receiver 26. This embodiment features an aperture positioned within the member 22. The aperture may be completely contained within the member 22, or may extend through one of the first and second sides.

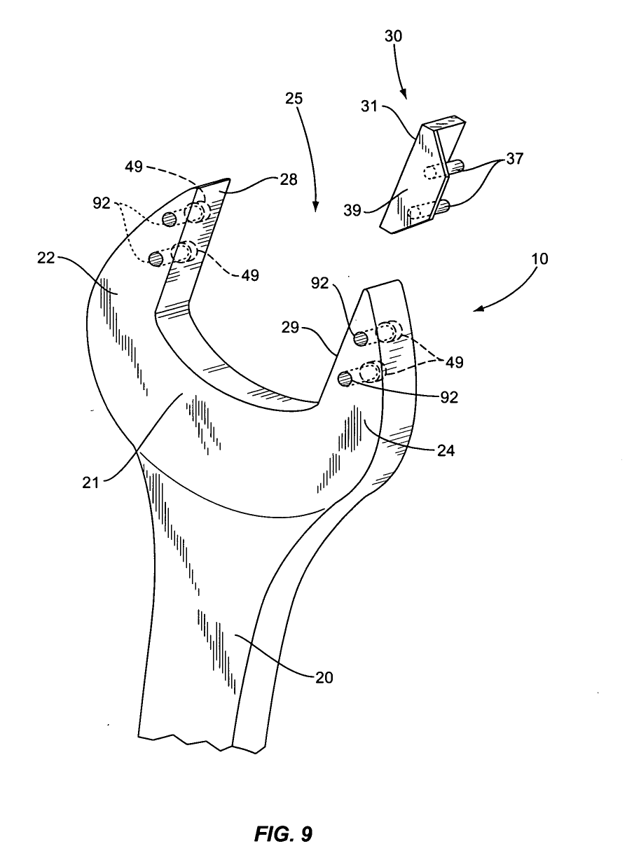

FIG. 9 illustrates another embodiment of a mount 30 having a mounting platform 39 attached to the first section 31. Studs 37 extending outward from the mounting platform 39 are inserted into the receptacles 92 to attach the mount 30 to the member 24. Magnets 49 may be mounted within or adjacent to the receptacles 92. The studs 37 are constructed of a metallic material that are attracted to and held in position by the magnets 49.

Mounts 30 include a first section 31 positioned within the opening 25, and a second section 32 positioned to the receiver 26. As with the receivers 26, mounts 30 may have a variety of shapes and sizes depending upon the application. FIGS. 1 and 3 illustrate one embodiment that is substantially C-shaped. The first section 31 is positioned within the opening 25 in front of the first edge 28, with the second section 32 having extensions that mount within the indents of the receiver 26. FIG. 4 illustrates another embodiment having a partial “H” shape with the first section 31 within the opening 25 in front of the first edge 28, and the second section 32 mating within the T-shaped void. FIG. 6 illustrates another embodiment with the first section 31 within the opening 25 and the second section 32 having an arm that fits within the aperture.

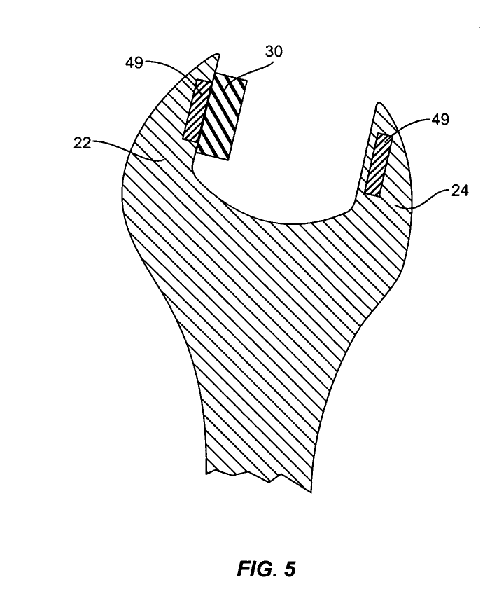

Magnets 49 may further be positioned within one or both of the first and second members 22, 24 for maintaining the positioning and attachment of the mounts 30. The mounts 30 may be constructed of a magnetically-attracted material such that they are pulled towards the magnets 49. Magnets 49 may be positioned completely within the member as illustrated with the second member 24 of FIG. 5, or be exposed to directly contact the mount 30 as illustrated on the first member 22 of FIG. 5.

First and second members 22, 24 may further include positioning members for accurately positioning and maintaining the mounts 30. In one embodiment, positioning members include a ball detent 71 and aperture 72. Ball detent 71 is biased outwardly from the member 24 at a point to contact the mount 30. In the embodiment illustrated in FIG. 1, ball detent 71 is positioned within the receiver 26. Mount 30 includes an aperture 72 that extends over the ball detent 71 when accurately positioned. In the embodiment of FIG. 1, the aperture 72 is positioned within the second section 32 of the mount 30. One or both members 22, 24 may also include recessed alignment edges (not illustrated) for locating the mounts 30.

One or more holders 80 may be positioned to maintain the mounts 30 when they are not connected to the first or second members 22, 24. Holders 80 have the same physical structure as the receivers 26 previously described to receive the second section 32 of the mounts 30. One or more holders 80 may be placed at any location on the wrench 20, including the body 21 as illustrated in FIG. 2, or on the handle 79 as illustrated in FIG. 8. In one embodiment, holders 80 are positioned such that the shape of the mount 30 corresponds to the shape of the wrench 20.

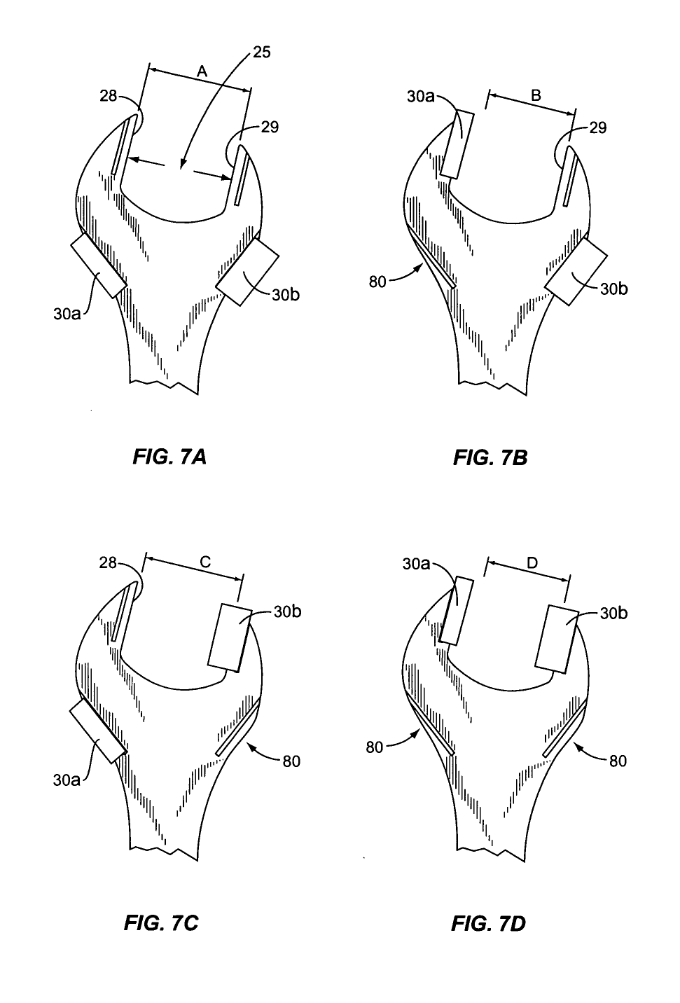

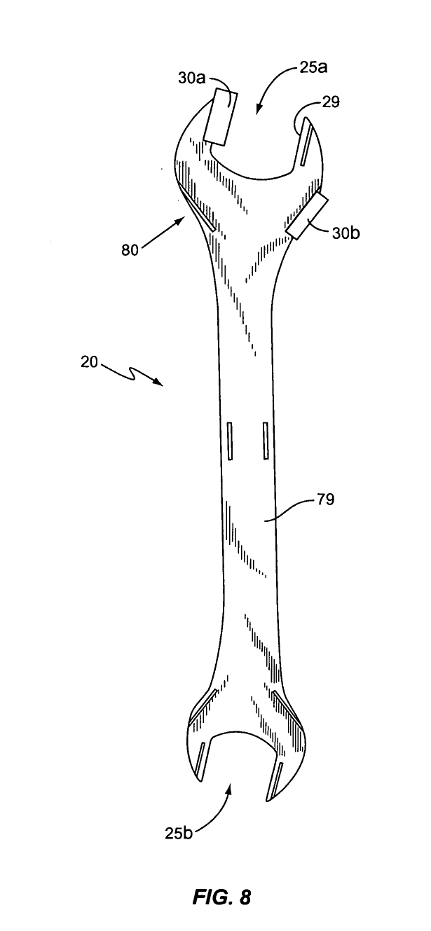

One method of using the wrench 20 is illustrated in FIGS. 7A-7D. In a first manner of use as illustrated in FIG. 7A, neither mount 30a, 30b is in use. The opening 25 has a width A defined by the first edge 28 and the second edge 29. This orientation is the largest size that the wrench 20 can achieve. If the work piece is smaller than the width A, one of the mounts 30a can be attached as illustrated in FIG. 7B. Mount 30a has a first section 31 having a width mounted within the opening 25. The mount 30a reduces the overall width of the opening 25 to a width B which is smaller than width A. A work piece that is manipulated in this orientation is contacted by an inner edge of mount 30a and the second edge 29.

Another orientation is illustrated in FIG. 7C with the mount 30a removed from the first member 22 and the second mount 30b placed onto the second member 24. Second mount 30b has a first section 31 having a greater width than mount 30a. Therefore, the overall width C of this embodiment is smaller than width B. A work piece manipulated in this orientation is contacted by the first edge 28 and the inner edge of mount 30b. Another orientation is illustrated in FIG. 7D with both mounts 30a, 30b attached to the members 22, 24. The overall width of the opening 25 is reduced by the width of first sections of each of the mounts 30a, 30b forming an overall width D. A work piece manipulated in this orientation is contacted by an inner edge of mount 30a and an inner edge of mount 30b. As illustrated in FIGS. 7A, 7B, and 7C, mounts 30a, 30b are placed on the holders 80 when not in use within the opening 25. In one embodiment, mount 30a has a first section 31 of about 1/16 inch, and mount 30b has a first section 31 of about 1/8 inch.

Additional mounts 30 having different first section widths may also be used to add further variability to the sizing. By way of example, another mount 30 having a width different than mounts 30a, 30b may be used in the mix of combinations.

FIG. 8 illustrates another embodiment of the wrench 20 having a first opening 25a sized to received work pieces in a first unit system, such as English units (e.g., inches). Second opening 25b is on an opposite end and sized to receive work pieces in a second unit system, such as metric units (e.g., centimeters). Mounts 30a, 30b are sized to be connected within either opening 25a, 25b. Therefore, this wrench has more adaptability for use on different construction of work pieces. Mounts 30a, 30b are placed in holders 80 when not in use.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A device for mounting to a work piece comprising:
an open-ended wrench having a first section and a second section defining an opening therebetween having an opening width;
a first receiver extending into the first section and along the opening, and a second receiver extending into the second section and along the opening;
a first mount sized to be removably attached to the first section, the first mount having a first extension and a first reducer having a first predetermined width, the first extension sized to fit within the first receiver and position the first reducer into the opening to reduce the opening width by the first predetermined width; and
a second mount sized to be removably attached to the second section, the second mount having a second extension and a second reducer having a second predetermined width, the second extension sized to fit within the second receiver and position the second reducer into the opening to reduce the opening width by the second predetermined width;
a sum of the first predetermined width and the second width being less than the opening width.

2. The device of claim 1, wherein the first receiver and the second receiver are identical.

3. The device of claim 1, wherein the first receiver is substantially parallel with the second receiver.

4. The device of claim 1, wherein the first receiver extends into the first member inward from the opening and the second receiver extends into the second section inward from the opening.

5. The device of claim 4, wherein the first receiver and the second receiver each have a substantially “T”” shape.

6. The device of claim 1, further comprising magnets mounted within each of the first section and the second section to position the first reducer and the second reducer in the opening.

7. The device of claim 6, wherein the magnets are exposed in the opening.

8. The device of claim 1, wherein each of the first mount and the second mount are substantially “C” shaped.

9. The device of claim 1, wherein each of the first mount and the second mount are substantially H shaped.

10. The device of claim 1, wherein the first mount extends around first member sidewalls and the second mount extends around second member sidewalls.

11. A device to mount to a work piece comprising:
a wrench having first and second members spaced apart to form an opening therebetween with an open side to introduce the work piece into the opening;
a receiver on the wrench adjacent to the opening; and
a mount having a first section and a second section, the first section having a predetermined thickness and being positioned within the opening to reduce a width of the opening, and the second section mating with the receiver to position the first section within the opening.

12. The device of claim 11, wherein the receiver is a slot formed into the first member substantially parallel to an opening edge, and the second section comprises an extension that mounts within the slot.

13. The device of claim 11, further comprising a magnet mounted within the first section to attach the mount to the receiver.

14. An adjustable open-ended wrench comprising:
a first section having a first edge and a second section having a second edge, the first edge and the second edge being spaced apart a distance with an opening therebetween having an opening width;
a first receiving groove extending into the first section and extending substantially parallel with the first edge;
a second receiving groove extending into the second section and extending substantially parallel with the second edge;
a first mount having a first section with a first width and a second section, the second section being sized to fit within the first receiving groove such that the first section is positioned within the opening to reduce the opening width by the first width; and
a second mount having a third section with a second width and a fourth section, the fourth section being sized to fit within the second receiving groove such that the third section is positioned within the opening to reduce the opening width by the second width.

15. A method of adjusting a size of an open-ended wrench to fit a work piece, the method comprising the steps of:
connecting a first mount to a first section with a first reducer positioned within an opening to reduce the opening to a first width that is less than an original width;
removing the first mount from the first section and connecting a second mount to a second section with a second reducer positioned within the opening and reducing the opening to a second width that is less than the first width; and
reconnecting the first mount to the first section with the reducer positioned within the opening and reducing the opening to a third width that is less than the second width.

16. The method of claim 15, further comprising mounting the first mount on a receiver on the open-ended wrench at a position away from the opening when the first mount is not in use within the opening.

17. The method of claim 16, further comprising mounting the second mount on a second receiver on the open-ended wrench away from the opening when the second mount is not in use within the opening.

18. The method of claim 15, further comprising using a magnet within the first section to locate the first reducer within the opening and using a second magnet within the second section to locate the second reducer within the opening.

19. A method of using a single open-ended wrench on a plurality of different sized work pieces, the method comprising the steps of:
positioning an opening around a first work piece with a first section and a second section contacting the first work piece;
mounting a first mount on a first section exterior edge and positioning the opening around a second work piece with the first mount and the second section contacting the second work piece, the second work piece being smaller than the first work piece;
mounting a second mount on a second section exterior edge and positioning the opening around a third work piece with the first section and the second mount contacting the third work piece, the third work piece being smaller than the second work piece; and
mounting the first mount on the first section exterior edge and mounting the second mount on a second section exterior edge and positioning the opening around a fourth work piece with the first mount and the second mount contacting the fourth work piece, the fourth work piece being smaller than the third work piece.
